(19) United States
(12) Patent Application Publication
(10) Pub. No.: US 2026/0234071 A1
(43) Pub. Date: Aug. 13, 2026

(54) TREATMENT OF CONTAMINATED CONCRETE

(71) Applicant: KI Strategies Pty Ltd, Parkville (AU)

(72) Inventors: Andrew Kita, Lilyfield (AU); Grant Scott, Parkville (AU)

(21) Appl. No.: 19/051,775

(22) Filed: Feb. 12, 2025

Related U.S. Application Data
(63) Continuation-in-part of application No. PCT/AU2024/051155, filed on Oct. 31, 2024.

(30) Foreign Application Priority Data
Oct. 31, 2023 (AU) 2023903482

(51) Int. Cl. C04B 41/50; C04B 41/00; C04B 41/45; C04B 41/85; C04B 103/65; C04B 111/00

(52) U.S. Cl. CPC C04B 41/5089; C04B 41/009; C04B 41/4539; C04B 41/5079; C04B 41/85; C04B 2103/65; C04B 2111/00017

(57) ABSTRACT

The present invention relates to a method of reducing leaching and contamination from concrete and like cementitious materials that has been contaminated with per- and poly-fluoralkyl substances (‘PFAS’). The present invention additionally relates to a method of treating concrete and like cementitious materials that have been contaminated with PFAS to reduce the leaching of PFAS therefrom, and further provides a method of producing a PFAS impermeable concrete or like cementitious product.

### CROSS-REFERENCE TO RELATED APPLICATION(S)

The present application is a continuation-in-part of and claims priority of International patent application Serial No. PCT/AU/2024/051155, filed Oct. 31, 2024, as well as Australian application No AU 2023903482, filed Oct. 31, 2023, the content of each of which is hereby incorporated by reference in its entirety.

### FIELD

The present invention relates to a method of reducing leaching and contamination from concrete and like cementitious materials that has been contaminated with per- and poly-fluoralkyl substances (‘PFAS’). The present invention additionally relates to a method of treating concrete and like cementitious materials that have been contaminated with PFAS to reduce the leaching of PFAS therefrom, and further provides a method of producing a PFAS impermeable concrete or like cementitious product.

### BACKGROUND

PFAS are a family of chemicals found in a wide variety of consumer and retail products. Thousands of different PFAS compounds are known, some being more widely used and understood than others. Many PFAS are resistant to heat, water, grease, and oil and have therefore been used in a variety of applications including in stain- and water-resistant fabrics, cleaning products, paints, and firefighting foams.

Recent studies suggest that at least some PFAS are bio-accumulative, and that the bioaccumulation of PFAS within humans and animals can have serious adverse health effects, potentially including carcinogenic effects even at relatively low concentrations. Additionally, PFAS can be chemically quite stable as well as soluble, such that PFAS levels in the environment, including in soil and groundwater, can increase over time which in turn increases the risk of health effects, and impact to the environment.

As mentioned above, PFAS have historically been used in aqueous film forming foams (AFFF) used for firefighting. During a fire, such as an inflammable liquid fire, firefighting foams can often be used quite liberally to douse the fire. The result is that following a fire, sites where foams have been used historically can be contaminated with PFAS. Therefore, sites where chemical fires can occur, or have occurred, such as: fire response training facilities, airports, military facilities, fuel refineries and storage facilities, ports, and chemical plants have become quite contaminated over time.

PFAS may leach from such facilities into underlying soil, groundwater, and nearby surface water receptors. Concrete, bitumen, and other commonly used structural materials are porous, and allow PFAS that have previously leached into the matrix of the material to slowly leach out to contaminate the nearby environment. It has further been generally understood that PFAS will leach under alkaline conditions as generally present within cementitious materials.

Further, PFAS are understood to be capable of travel over long distances via surface water, groundwater and other mechanisms such as wind transport of contaminated soils, and will bioaccumulate in food sources such as fish. Given the above, PFAS represent a significant health risk to the community such that PFAS contamination management remains a significant issue. Recent examples of such risks include the town of Katherine, NT, where PFAS contamination from the Tindal RAAF Base has contaminated groundwater and the Katherine River, which the town relies on for its drinking water supply.

To date, the focus of PFAS contamination management has been on clean-up/remediation of soils and the water to remove existing contamination. For example:

PCT Patent Publication WO 2017/131972 A1, in the name of Oxytec LLC, describes a process for the remediation of contaminated soils, ground water and waste. PFAS within the contaminated materials are treated in either in situ or in an ex-situ reactor to destroy, breakdown, or defluorinate the contaminating PFAS. The PFAS are treated with a reactant such as: persulphate, oxygen, ozone, hydrogen peroxide or maltodextrin.

PCT Patent Publication WO 2019/113268 A1, in the name of Eminus LLC, effectively describes a froth flotation system for the decontamination of water containing PFAS contaminants. The system comprises introducing a foaming agent to the water, and injecting a gas through a diffuser into the water so as to form bubbles such that the PFAS contaminants accumulate in the bubbles which are then scooped as foam from the surface of the water.

PCT Patent Publication WO 2010/065996, in the name of CRC Care Pty Ltd, discloses a modified clay sorbent which may be used for the sorption of PFAS. According to particular embodiments, the modified clay comprises a palygorskite clay modified with a cationic surfactant. WO 2010/065996 further discloses a method of separating a contaminant such as PFAS from a contaminated sample by contacting the contaminated sample with the modified clay sorbent.

US Patent Publication 2019/0314876 A1, in the name of TRS Group Inc, describes a method to remediate soils containing PFAS and organic carbon, in which the soil is heated at a sufficient temperature and for a sufficient duration to reduce surface effects between the organic carbon and the PFAS to permit evaporation of the PFAS.

The above exemplified methods establish techniques for remediating loose soil but fail to provide a solution to the issue of PFAS leaching from contaminated concrete and similar cementitious materials, noting that concrete is not generally a loose particulate product enabling methods such as froth flotation separation or mixing a modified clay sorbent into the existing product as exemplified above.

It is an object of the present invention to provide a method of dealing with PFAS-contaminated concrete or like cementitious products, which overcomes one or more of the deficiencies with the existing art, or at least provides a viable alternative. It is a further object to provide a pre-emptive or preventative means for managing the risk of PFAS contamination in areas that are at risk of PFAS exposure, which overcomes one or more of the deficiencies with the existing art, or at least provides a viable alternative.

In certain embodiments, the present invention provides a product for use in locations at risk of PFAS contamination, such as in locations having increased risk of oil and related hydrocarbon-based fuel fires.

The reference in this specification to any prior publication, or information derived from it, or to any matter which is known, is not, and should not be taken as an acknowledgement or admission or any form of suggestion that the prior publication, or information derived from it, or known matter forms part of the common general knowledge in the field of endeavour to which this specification relates.

### SUMMARY

According to a first aspect of the invention, there is provided a method of treating a cementitious product that is contaminated with PFAS to reduce leaching of PFAS from the cementitious product, the method comprising:
treating a surface of the cementitious product with a penetrating sealer composition; and
allowing the penetrating sealer composition to permeate into the cementitious product and cure within the cementitious product.

In an embodiment, the step of allowing the penetrating sealer composition to permeate into the cementitious product comprise allowing the penetrating sealer to permeate at least 3 mm into the cementitious product.

In an embodiment, the method further comprises pre-treating the cementitious product to prepare the surface of the cementitious product for treatment with the penetrating sealer composition.

In an embodiment, the step of pretreating the cementitious product comprises a treatment step to remove hydrocarbons and solvents from the surface of the cementitious product.

In an embodiment, the step of pretreating the cementitious product comprises conducting a water wash or water soak of the surface of the cementitious product.

In an embodiment, the step of pretreating the cementitious product comprises applying a base treatment composition to the surface of the cementitious product, the base treatment composition comprising as dry components:
15-80% cement;
5-50% alkaline earth compounds; and
20-70% silica sand.

In an embodiment, the step of treating a surface of the cementitious product with a penetrating sealer composition comprises applying the cementitious product via brush application, roller application or spray application.

In an embodiment, the penetrating sealer composition is a densifying penetrating sealer composition.

In an embodiment, the penetrating sealer composition is a silicate-based penetrating sealer composition or a silica-based penetrating sealer composition.

In an embodiment, the penetrating sealer composition is a sodium silicate-based penetrating sealer composition, a potassium silicate-based penetrating sealer composition, a lithium silicate-based penetrating sealer composition or a colloidal silica-based penetrating sealer composition.

In an embodiment, the penetrating sealer composition is a water repellant penetrating sealer composition.

In an embodiment, the penetrating sealer composition is selected from the group of: siliconate-based penetrating sealer composition, a siloxane-based penetrating sealer composition, or a silane-based penetrating sealer composition.

In an embodiment, the method further comprises applying a further application of an additional penetrating sealer composition to the surface of the cementitious product following the initial application of a penetrating sealer composition.

In an embodiment, the further application of a penetrating sealer composition is applied between 1 and 72 hours after the initial application.

According to a second aspect of the invention, there is provided a method of treating a cementitious product that is contaminated with PFAS to reduce leaching of PFAS from the cementitious product, the method comprising:
treating a surface of the cementitious product with a base treatment composition, the base treatment composition comprising as dry components:
15-80% cement;
5-50% alkaline earth compounds; and
20-70% silica sand; and
allowing the base treatment composition to permeate into the cementitious product and cure within the cementitious product.

In an embodiment according to the second aspect of the invention, the base treatment composition comprises as dry components:

| | | |
|---|---|---|
| Cement | 15% | 80% |
| Alkaline Earth Compounds | 5% | 50% |
| Silica Sand/Quartz | 20% | 70% |
| Sodium carbonate | 5% | 30% |
| Calcium aluminates | 0 | 15% |
| Iron oxide | 0 | 10% |
| Limestone | 0 | 10% |
| Gypsum | 0 | 5% |
| Titanium dioxide | 0 | 5% |

In an embodiment according to the second aspect of the invention, the base treatment composition comprises as dry components:
35-60% cement;
5-20% alkaline earth compounds; and
30-40% silica sand.

In an embodiment according to the second aspect of the invention, the base treatment is applied to the surface of the cementitious product at a rate of 0.3-2.0 kilograms of dry components per square metre.

In an embodiment according to the second aspect of the invention, the base treatment composition is applied to the surface of the cementitious product at a rate of 0.6-1.2 kilograms of dry components per square metre.

In an embodiment according to the second aspect of the invention, the method further comprises maintaining the surface of the cementitious product in a moist condition following application of the base treatment composition to facilitate curing of the base treatment composition.

In an embodiment according to the second aspect of the invention, the surface of the cementitious product is kept moist following application of the base treatment composition for between 2 to 7 days.

In an embodiment according to the second aspect of the invention, the method further comprises applying a second application of base treatment composition after applying the initial application.

In an embodiment according to the first or second aspects of the invention, the cementitious product is a concrete slab, a culvert, or a concrete pipe.

In an embodiment according to the first or second aspects of the invention, the process comprises breaking up the cementitious product prior to treatment with any composition.

According to a third aspect of the invention, there is provided a method of producing a PFAS impermeable cementitious product, the method comprising:
identifying a cementitious product as having an increased likelihood of PFAS contamination, the cementitious product not being subject to any pre-existing substantial PFAS contamination;
treating a surface of the cementitious product with a penetrating sealer composition; and
allowing the penetrating sealer composition to permeate into the cementitious product and cure within the cementitious product.

In an embodiment according to the third aspect of the invention, the step of allowing the penetrating sealer composition to permeate into the cementitious product comprise allowing the penetrating sealer to permeate at least 3 mm into the cementitious product.

In an embodiment according to the third aspect of the invention, the method further comprises pre-treating the cementitious product to prepare the surface of the cementitious product for treatment with the penetrating sealer composition.

In an embodiment according to the third aspect of the invention, the step of pretreating the cementitious product comprises a treatment step to remove hydrocarbons and solvents from the surface of the cementitious product.

In an embodiment according to the third aspect of the invention, the step of pretreating the cementitious product comprises conducting a water wash or water soak of the surface of the cementitious product.

In an embodiment according to the third aspect of the invention, the step of pretreating the cementitious product comprises applying a base treatment composition to the surface of the cementitious product, the base treatment composition comprising as dry components:
15-80% cement;
5-50% alkaline earth compounds; and
20-70% silica sand.

In an embodiment according to the third aspect of the invention, the step of treating a surface of the cementitious product with a penetrating sealer composition comprises applying the cementitious product via brush application, roller application or spray application.

In an embodiment according to the third aspect of the invention, the penetrating sealer composition is a densifying penetrating sealer composition.

In an embodiment according to the third aspect of the invention, the penetrating sealer composition is a silicate-based penetrating sealer composition or a silica-based penetrating sealer composition.

In an embodiment according to the third aspect of the invention, the penetrating sealer composition is a sodium silicate-based penetrating sealer composition, a potassium silicate-based penetrating sealer composition, a lithium silicate-based penetrating sealer composition or a colloidal silica-based penetrating sealer composition.

In an embodiment according to the third aspect of the invention, the penetrating sealer composition is a water repellant penetrating sealer composition.

In an embodiment according to the third aspect of the invention, the penetrating sealer composition is selected from the group of: siliconate-based penetrating sealer composition, a siloxane-based penetrating sealer composition, or a silane-based penetrating sealer composition.

In an embodiment according to the third aspect of the invention, the method further comprises applying a further application of an additional penetrating sealer composition to the surface of the cementitious product following the initial application of a penetrating sealer composition.

In an embodiment according to the third aspect of the invention, the further application of a penetrating sealer composition is applied between 1 and 72 hours after the initial application.

According to a fourth aspect of the invention, there is provided a method of producing a PFAS impermeable cementitious product, the method comprising:
identifying a cementitious product as having an increased likelihood of PFAS contamination, the cementitious product not being subject to any pre-existing substantial PFAS contamination;
treating a surface of the cementitious product with a base treatment composition, the base treatment composition comprising as dry components:
   15-80% cement;
   5-50% alkaline earth compounds; and
   20-70% silica sand; and
allowing the base treatment composition to permeate into the cementitious product and cure within the cementitious product.

In an embodiment according to the fourth aspect of the invention, the base treatment composition comprises as dry components:
35-60% cement;
5-20% alkaline earth compounds; and
30-40% silica sand.

In an embodiment according to the fourth aspect of the invention, the base treatment is applied to the surface of the cementitious product at a rate of 0.3-2.0 kilograms of dry components per square metre.

In an embodiment according to the fourth aspect of the invention, the base treatment composition is applied to the surface of the cementitious product at a rate of 0.6-1.2 kilograms of dry components per square metre.

In an embodiment according to the fourth aspect of the invention, the method further comprises maintaining the surface of the cementitious product in a moist condition following application of the base treatment composition to facilitate curing of the base treatment composition.

In an embodiment according to the fourth aspect of the invention, the surface of the cementitious product is kept moist following application of the base treatment composition for between 2 to 7 days.

In an embodiment according to the fourth aspect of the invention, the method further comprises applying a second application of base treatment composition after applying the initial application.

According to a fifth aspect of the invention, there is provided a cementitious product for creating an impermeable barrier to PFAS contamination, the cementitious product produced according to the method of any of the previous embodiments.

In an embodiment according to the fifth aspect of the invention, the cementitious product is a concrete product, optionally a pre-cast concrete product.

In an embodiment according to the fifth aspect of the invention, the cementitious product is used in an area that is at increased risk of chemical fire.

Throughout this specification and the claims which follow, unless the context requires otherwise:
“comprise” and variations thereof such as “comprises” and “comprising”, will be understood to include the inclusion of a stated integer or step or group of integers or steps but not the exclusion of any other integer or step or groups of integers or steps;
all specified percentages relate to wt/wt percentages;
reference to “a cementitious product contaminated with PFAS” includes reference to “a cementitious product with an increased likelihood of PFAS contamination”;
reference to like numbers in reference to features denotes reference to like features;
the use of ‘(s)’ following a noun means the plural and/or singular form of that noun; ‘and/or’ means ‘and’ or ‘or’, or where the context allows both;
reference to “a” or “one” thing, includes a reference to “one or more” of that thing;
terms such as “side,” “end,” “top,” “bottom,” and the like are only used to describe elements as they relate to one another but are in no way meant to recite specific orientations of the device, to indicate or imply necessary or required orientations of the device, or to specify how the invention described herein will be used, mounted, displayed, or positioned in use.

The present summary is provided only by way of example and not limitation. Other aspects of the present invention will be appreciated in view of the entirety of the present disclosure, including the entire text, claims, and any accompanying figures.

### DETAILED DESCRIPTION

The present invention is described by way of non-limiting examples within the following description. To those skilled in the art to which the invention relates, many changes in construction and widely differing embodiments and applications of the present invention will suggest themselves without departing from the scope of the present invention as defined in the appended claims. The disclosures and the descriptions herein are purely illustrative and are not intended to be in any sense limiting. Where specific integers are mentioned herein, which have known equivalents in the art to which this invention relates; such known equivalents are deemed to be incorporated herein as if individually set forth.

In broad terms the invention is directed to a method of treating a cementitious product contaminated with PFAS with a base treatment composition and/or a penetrating sealer composition.

PFAS has been understood to penetrate and leach from concrete and like cementitious materials into nearby soils and groundwater over time. Moreover, one of the primary mechanisms in which PFAS may leach from concrete involves water runoff from concrete slab surfaces. As discussed above, PFAS contaminates cementitious materials by being transported through the cementitious materials while entrained with water. As the water dries the PFAS is left located within the cementitious materials. This leaves the PFAS to leach from the cementitious materials over time whenever the cementitious materials are wet again. For example, during a storm event stormwater may pass into the cementitious materials and mix with PFAS entrained within the cementitious materials. This results in stormwater contaminated with PFAS passing out of the cementitious materials as runoff to contaminate the local environment.

While the amount of contamination enabled by the above-exemplified process may in the first instance seem trivial, contamination in the range of parts per billion is sufficient to raise environmental and health concerns. This creates huge issues for existing sites such as fire fighting training sites, airports, and military sites that include concrete slabs contaminated with PFAS. For many of these sites, removal of the contaminated concrete would be costly and cause an unacceptable disruption to the operation of the site (e.g. removal of an airport runway would cause an unacceptable disruption to the operation of an airport.), yet continuing contamination represents an unacceptable risk to the employees, the environment, and the community, such risk being raised each time water (e.g. stormwater) passes over the concrete slab. Further, the contaminated concrete would even once removed from the site need to be dealt with as a PFAS contaminated product-whether for example through remediation processing or safe storage.

The above issues may be addressed by the invention which broadly provides a method of reducing the leaching of PFAS from the cementitious product as installed and in situ.

In an embodiment, the invention provides a method of reducing the leaching of PFAS from a PFAS-contaminated cementitious product, the method comprising:
treating a surface of the cementitious product with a penetrating sealer composition; and
allowing the penetrating sealer composition to permeate into the cementitious product and cure within the cementitious product.

The inventors have discovered that treatment of a contaminated cementitious product with a penetrating sealer composition will interfere with a key mechanism enabling leaching of PFAS. As noted above, PFAS will leach from a concrete slab during storm events and the like, where storm water runs along the surface of the concrete slab and permeates the concrete slab enabling PFAS to transport with the storm water out of the concrete slab through the same surface. In this way a PFAS-contaminated concrete slab becomes a contamination risk to the broader environment for each storm event. The same issues apply to washing a concrete slab with water, such as through a hose and other like events. Treating the concrete slab with a penetrating sealer composition according to an embodiment of the invention reduces water transport into and out of the concrete slab to prevent or significantly reduce the PFAS leaching from the concrete to contaminate the local environment. Further, given that penetrating sealers penetrate and bond into the top sub-surface of the concrete, application of a penetrating sealer provides sustained protection against PFAS leaching without the need for regular reapplication as would otherwise be required with topical sealers that do not penetrate into the cementitious product (also known as film-coating or surface coating sealers) and are therefore subject to wear and environmental conditions such as UV radiation.

In a preferred embodiment, the cementitious product is pre-treated (prior to application of a penetrating sealer) with one or more applications of a base treatment composition for penetrating deep into the cementitious product (preferably more than 5-10 cms into the cementitious product) and filling pores of the cementitious product. Application of a base treatment composition is intended to significantly reduce porosity and water permeability deep into the cementitious product. When combined with the later application of a penetrating sealer, it is believed that application of the base treatment composition may:
assist in ensuring that the later application of the penetrating sealer will provide a complete or substantially complete seal within the top layer of the cementitious product. That is, the base treatment composition will reduce the porosity of the cementitious product and contribute to ensuring that the penetrating sealer does not penetrate too deeply into the cementitious product and thereby provide incomplete sealing in the top layer of the cementitious product.
provide additional resistance to leaching of PFAS in case of any breaches within the sealed top layer of the cementitious product as may result from incomplete sealing, a component of the sealed top layer breaking off, or a crack forming in the sealed top layer. That is, should any water transport break through the sealed top layer, use of the base treatment composition will nevertheless reduce the likelihood or extent of any resulting release of PFAS.
fill pre-existing small cracks and hairline cracks within the cementitious product structure. That is, according to certain embodiments of the invention, the base treatment composition may comprise some solid components capable of filling cracks in the cementitious product structure while other components penetrate deep into the cementitious product structure to reduce the porosity of the cementitious product. This may for example assist in enabling the penetrating sealer to provide a thorough seal in the top layer of the concrete.
potentially (subject to matters such as the thickness of the cementitious product), render a cementitious product suitable for later disposal (if desired) as a non-contaminated material (or a contaminated material of lower grading or classification). As discussed above, the safe disposal of a PFAS contaminated cementitious product will typically require remediation processing or safe storage under regulated conditions. While the invention is intended to reduce leaching of PFAS from a contaminated cementitious product in situ (so that the cementitious product can continue to be used as installed), treatment with a base treatment composition may result in a cementitious product that demonstrates sufficiently reduced PFAS leaching for disposal (subject to local regulation) even if broken up as part of disposal processing. In another embodiment, the invention may relate to treating broken up cementitious materials (e.g. concrete rubble) to enable safe storage as a safe or lower grade contaminated product.

In an alternative embodiment, a cementitious product may be treated with a base treatment composition without any later treatment with a penetrating sealer. That is, subject to specific conditions and requirements, deep penetrating densification of the cementitious product (as may be provided through application of a base treatment composition) may provide a sufficient reduction in the leaching of PFAS from the cementitious product without the need for any later treatment with a penetrating sealer to seal the top surface of the cementitious product.

### Base Treatment Composition

A base treatment composition in accordance with embodiments of the invention to penetrate deep (e.g. at least 5-10 cms) into the cementitious product and reduce the porosity of cementitious product across the range of penetration, without necessarily sealing the top layer of the cementitious product (e.g. the top 3-40 mm).

According to certain embodiments, a base treatment composition may possess a dry component composition comprising
15-80% cement;
5-50% alkaline earth compounds; and
20-70% silica sand.

According to other embodiments the dry components of the base treatment composition may comprise:
35-60% cement;
5-20% alkaline earth compounds; and
30-40% silica sand.

According to other embodiments, the dry components of the base treatment composition may comprise

| | % from | % to |
|---|---|---|
| Cement | 15% | 80% |
| Alkaline Earth Compounds | 5% | 50% |
| Silica Sand/Quartz | 20% | 70% |
| Sodium carbonate | 5% | 30% |
| Calcium aluminates | 0 | 15% |
| Iron oxide | 0 | 10% |
| Limestone | 0 | 10% |
| Gypsum | 0 | 5% |
| Titanium dioxide | 0 | 5% |

According to certain embodiments, cement incorporated into the base treatment composition may comprise Portland cement, however use of other cements s known to the personal skilled in the art is envisaged. In alternative embodiments the cement may comprise other cements such as calcium aluminate cements and pozzolan cements.

When using any of the dry component compositions exemplified above, the dry components should be mixed with water no earlier than 20-30 minutes prior to application, and the amount mixed should not exceed what can be applied within approximately 20 minutes, noting that the mixture may commence curing reactions immediately upon mixing. The mixing ratio used may depend upon the manner in which the mixture is applied.

According to certain embodiments, the mixture may be applied by brush application or by spray application, where for example:
for brush application, five to six parts dry components may be generally mixed with two parts water to achieve the required consistency; or
for spray application, five parts dry components may be generally mixed with three parts water to achieve the required consistency. During brush application, a semi-stiff short bristle broom may be used to work the base treatment composition into the surface of the cementitious product while ensuring that any hairline cracks are filled.

During spray application, the spray device should be capable of applying the base treatment composition at sufficient force to ensure that the base treatment composition is worked into the surface. For this purpose, an application pressure of 30-40 PSI is generally sufficient.

Other methods of application may be envisaged. For example, if the cementitious product to be treated is concrete rubble, the application could be conducted by way of a conveyer based system for example.

Following application of the mixture, the treated surface may be kept moist to maximise curing and the filling of deep pores in the cementitious product. For example, if the cementitious product is a horizontal concrete slab, moisture may be maintained:
by way of periodic misting using a spray of clean water, noting that care should be taken to avoid puddling. Under normal conditions, misting three times per day is sufficient though more frequent misting may be appropriate in hotter arid conditions;
by way of curing blankets such as those with a polymer film attached to a layer of absorbent fiber material-noting that any polymer film should be separated from the cementitious product to allow the base treatment composition to breathe during curing; and
by way of a wet burlap covered with a polymer film.
   According to certain embodiments the cementitious product should be kept from drying out for approximately three days (depending upon the curing period of the mixture).

To further maximise the effectiveness of the base treatment composition, more than one application of the mixture may be applied to the surface of the cementitious product. Any further application should ideally be applied while the initial application still cures, ideally within 48 hours of the initial application.

If a penetrating sealer is to be applied following treatment with the base treatment composition, the penetrating sealer should be applied after curing of the base treatment has been completed. Curing of the base treatment typically takes at least 7-14 days.

### Penetrating Sealers

According to certain embodiments of the invention, a contaminated cementitious product may be treated with a penetrating sealer composition either following or as an alternative to treatment with a base treatment composition. If a penetrating sealer composition is used in conjunction with a base treatment composition, then the penetrating sealer may ideally be applied after the base treatment composition has had time to substantially cure. The appropriate amount will depend on factors such as environmental conditions, but may typically be in the order of 14 days or more.

Penetrating sealers are generally classified as either densifiers (also known as hardeners) or water repellents. Densifiers are typically premised on silicate chemistry (i.e. silicate-based penetrating hardeners) or silica chemistry (i.e silica-based penetrating hardeners), and while water repellents are also typically derived from silicon-based materials (e.g. silane-based penetrating sealers, siloxane-based penetrating sealers, and siliconate-based penetrating sealers), they operate by providing a water repellant quality within the top layer of the cementitious product. These silicon-based materials are water repellent but not generally oil repellant. Another category of water repellant sealer relates to fluorinated sealers, which are generally both water repellant and oil repellent. While use of fluorinated sealers is contemplated as falling within the scope of the present invention, their use is less preferred given the purpose of the invention relates to reduced environmental contamination with PFAS. Most penetrating sealers are water-based, though solvent-based penetrating sealers do exist.

### Silicate-Based Penetrating Sealers

Silicates react with alkalis and calcium hydroxide to form crystalline structures which “plug” the capillaries of porous cementitious surfaces. These crystalline structures (resulting from the reaction of silicates with alkalis and calcium hydroxides) are much the same as those that result from adding water to Portland cement and that give concrete much of its strength and hardness. Silicate-based penetrating sealers are commonly classified as densifiers/hardeners given the crystalline structures they form upon reaction with cementitious products serve to further densify and harden the cementitious product.

More generally, the crystalline structures that result from application of silicate based penetrating sealers: increase surface strength and abrasion resistance, block efflorescence, reduce dusting, but most relevantly for present purposes restrict absorption and transport of water. Depending on the smoothness of a surface, a silicate-based penetrating sealer may be burnished into a surface with a floor scrubber or diamond polisher to yield a polished appearance. This can improve the look of the surface while also making the surface easier to clean and maintain.

Silicate-based penetrating sealers are not generally considered a water repellent type sealer, as they do not repel water (or moisture, salts, or other impurities) like a true water repellents. Instead, they harden and densify (i.e. reduce the porosity of) cementitious product surfaces to the point where water and other substances are restricted entering the cementitious product surface. This is accomplished by the crystalline structures that form upon application of the silicate-based penetrating sealer. The crystalline structures plug the capillaries of the cementitious product surface. Silicate sealers are generally water based, low VOC and user and environmentally friendly.

Given the small molecule size of its reactants, controlling the depth of penetration is of particular importance with silicate-based penetrating sealers and greatly affects their sealing performance. That is, if a silicate-based penetrating sealer penetrates too deeply, as may occur with particularly porous cementitious products, the silicate-based penetrating sealer may nevertheless reduce the porosity of the cementitious product but not to the extent necessary to prevent water migration to a desired degree within the top layer of the cementitious product (e.g. from the top surface of the cementitious product to at least say 3-40 mm below top surface. As a result, a silicate-based penetrating sealer may require application in multiple coats, especially on more porous cementitious product surfaces. In a preferred embodiment, the cementitious product may be pretreated with a base treatment composition which reduces the porosity and permeability of the cementitious product prior to application of a penetrating sealer.

Three main types of silicate-based penetrating sealers exist, being sodium silicates, potassium silicates, lithium silicates. As discussed below, silica-based penetrating sealers similarly operate to plug the capillaries of porous cementitious surfaces.

### Sodium Silicate-Based Penetrating Sealers

The oldest and least expensive type of silicate-based penetrating sealers, having been used since the 1930s, are based on sodium silicates. Sodium silicate-based penetrating sealers are not as user friendly as potassium silicate- or lithium silicate-based penetrating sealers. This is due to sodium silicates often reacting with a cementitious product surface too quickly and prior to full penetration into the cementitious product surface. This results in much of the crystal forming chemical reaction taking place on the very surface instead of penetrating sufficiently into the capillaries of the cementitious product. In addition, byproducts from the chemical reaction occurring on the surface will often create a stubborn white residue that can be very difficult to remove from the cementitious product surface.

To overcome these drawbacks, it may (subject to manufacturer's directions) be considered necessary to dampen the surface prior to applying the sodium silicate-based penetrating sealer to break the surface tension which aids in allowing the sealer to achieve better penetration before chemically reacting with the cementitious product. Sometimes scrubbing a sodium silicate-based penetrating sealer into the surface is also helpful to achieve penetration prior to reaction chemical reaction with the cementitious product. It should be noted that some manufacturer's directions for application of a sodium silicate-based penetrating sealer to a dry surface.

### Potassium Silicate-Based Penetrating Sealers

Though generally more expensive than sodium silicate-based penetrating sealers, potassium silicate-based penetrating sealers tend to penetrate deeper due to potassium silicates having a slightly smaller molecular structures on average than sodium silicates. Potassium silicate-based penetrating sealers were developed to overcome many of the limitations of sodium silicate based penetrating sealers. Nevertheless, they continue to suffer from many of the same drawbacks (though generally to a lesser extent). Just like sodium silicate-based penetrating sealers, potassium silicate-based penetrating sealers often react too quickly with cementitious product and prior to the sealer sufficiently penetrating into the cementitious product surface to fill capillaries underlying the cementitious product surface.

Nevertheless, due to the smaller molecule size, potassium silicate-based penetrating sealers generally provide better penetration and less surface reaction than sodium silicate-based penetrating sealers.

### Lithium Silicate-Based Penetrating Sealers

Lithium silicate-based penetrating sealers are currently the most prevalent of all the silicate-based technologies and possess a much smaller molecular structure than sodium silicate technologies and potassium silicate technologies. They are generally more expensive than sodium silicate and potassium silicate technologies. However, they overcome the major drawbacks of the sodium silicate and potassium silicate technologies and are much more user friendly.

Lithium silicate-based penetrating sealers do not react as quickly with cementitious product as sodium silicate- and potassium silicate-based penetrating sealers, so they can further penetrate a cementitious product surface without surface wetting. They are also more likely to facilitate a chemical reaction within the capillaries underlying a surface as opposed to upon the very top of a surface.

Lithium Silicates also do not raise the pH level of a cementitious product. As a result, they generally do not lead to residual salts and other impurities being purged from the cementitious product surface and causing a whitening known as surface bloom. In addition, since lithium silicates do not raise the pH level of a cementitious product, they are much safer to apply to a cementitious product surface than sodium silicate- and potassium silicate-based penetrating sealers as they do not lead to harmful alkali silica reaction (ASR) which can occur in higher pH level surfaces in presence of water and certain reactive aggregates.

### Silica-Based Penetrating Sealers

Colloidal silica-based penetrating sealers are the most recent silicate/silica-based penetrating sealer technology. They have gained a following within approximately the last ten years. Colloidal silica-based penetrating sealers are generally more expensive than sodium silicate- and potassium silicate-based penetrating sealers, but less expensive than lithium silicate-based penetrating sealers.

Colloidal silica-based penetrating sealers are generally a mixture of liquid (typically water), and silica particles. That is, it involves a colloid and not a solution, unlike traditional silicate-based penetrating sealers. Particles in a colloidal silica-based penetrating sealer are measured in the nanoscale, and typically range in size from about 5-8 nm up to about 50 nm. Colloidal silica-based penetrating sealers typically have greater penetration capability and higher reactivity than traditional silicate-based penetrating sealers.

Colloidal silica-based penetrating sealers deliver virtually pure silica nanoparticles into a cementitious product surface, whereas traditional silicate-based penetrating sealers deliver silicates as a salt which may result in residual white discoloration on a treated surface that can be stubborn to remove. With colloidal silica-based penetrating sealers comprising about 99.5% pure silica, mineral salt deposits are generally not left behind. Over application of a Colloidal Silica can result in the silica drying on the surface and leaving behind loose, dry, brittle silica deposits (e.g. sand) that is typically easily swept away.

Colloidal silica-based penetrating sealers are not without their limitations. Since they include very little stabilizing agent, they are inherently far less stable than traditional silicate-based penetrating sealers. That is, colloidal silica-based penetrating sealers can lose their stability whereby silica will precipitate, rendering them unusable. This can happen in a number of scenarios:
temperature extremes (either extreme hot or cold);
changes in pH, as may be caused by the addition of certain surfactants or other chemicals often added to the traditional silicate based penetrating sealers to improve performance; and
the colloidal silica particles eventually losing charge and becoming unstable.

### Application of Silicate-Based Penetrating Sealers

A silicate-based penetrating sealer may for example be applied using a sprayer or a roller, though other methods of application are envisaged. In either case, the silicate-based penetrating sealer should be sprayed or rolled evenly across the surface, making sure not to leave puddles or dry patches. Generally, spraying or rolling in a back-and-forth manner should be avoided as it may lead to overlapping.

In applying a silicate-based penetrating sealer, one should generally follow manufacturer instructions. Generally (and subject to manufacturer instructions):

Where two coats are required, to ensure maximum densification, the second coat can be installed several hours following the first.

After about 30-40 minutes, it is recommended to use a clean, damp mop to remove any remaining silicate-based penetrating sealer to prevent or minimise formation of white residue.

The treated surface should be allowed to cure for at least 24 hours before subjecting it to foot traffic, and 48-72 hours before heavy use or exposure to water.

### Water Repellant Penetrating Sealers

As discussed above, water repellent penetrating sealers are typically derived from silicon-based materials (e.g. silane-based penetrating hardeners, siloxane-based penetrating hardeners, and siliconate-based penetrating hardeners). These materials are water repellent but not generally oil repellant.

### Silane Sealers

Silanes are considered a water repellent and they possess excellent hydrophobic characteristics. As such, they do a superior job of repelling water, moisture, salts, dirt, and other impurities. In addition, they also are superior for resisting mould, mildew, and fungus as well as protecting against freeze thaw and efflorescence.

Silanes penetrate into a cementitious surface to form cross linked silicone resinous membranes within the surface while remaining breathable. Silanes have a very small molecular structure and also are slow reacting which together allow for deeper penetration into a surface.

Like all penetrating sealers, Silanes do not generally alter the appearance or texture of a substrate. Silane-based penetrating sealers penetrate deep into cementitious product, due to their small molecular size. As a result, they have low coverage rates and the surface must be thoroughly saturated, often with several applications required to obtain an adequate seal.

Silanes can vary in VOC level, solid content and can be water- or solvent-based. Water-based products generally have a lower VOC and are more user and environmentally friendly. Solvent-based products normally have a higher VOC and require more care in using and storing due to their flammable/combustible characteristics and solvent odour. Solvent-based Silane sealers tend to penetrate more deeply than water-based variants.

### Siloxane-Based Penetrating Sealers

Siloxanes are considered a derivative of the silane family. Like a silane-based penetrating sealer, siloxane-based penetrating sealers penetrate into a cementitious surface to form cross-linked silicone resinous membranes penetrating the surface while remaining breathable. Siloxane-based penetrating sealers generally possess a mixture of different size particles so as to fill different size voids within the cementitious product. They normally have a silane component having a very small molecular structure, and a siloxane component having a comparatively larger molecular structure. As such, siloxane-based penetrating sealers are referred sometimes referred to as silane/siloxane-based penetrating sealers. These two components work together to achieve a good balance between penetration and coverage rates.

Like other penetrating sealers, siloxane-based penetrating sealers typically do not alter the appearance or texture of a cementitious product substrate.

### Siliconate-Based Penetrating Sealers

Siliconate is considered another derivative of the silane family. Siliconates penetrate into a cementitious surface to form cross-linked silicone resinous membranes within the surface while remaining breathable. Siliconate sealers possess a medium sized molecular structure and are considered a great workhorse sealer for a variety of dense or porous concrete, block, stucco, mortar, and grout surfaces.

Like most penetrating sealers, siliconate-based penetrating sealers normally do not alter the appearance or texture of a substrate. Because of their medium molecule size and moderate penetration, they generally provide very good coverage rates. Siliconate-based penetrating sealers are usually water-based with zero or very low VOCs making them both environmentally and user friendly.

### Application of Water Repellant Penetrating Sealers

A water repellant penetrating sealer may be applied in a similar manner to a silicate- or silica-based penetrating sealer. For example, a water repellant penetrating sealer may be applied using a sprayer or a roller, with a sprayer being preferred for larger surfaces (nothing that other methods of application are envisaged). In either case, the water repellant penetrating sealer should be sprayed or rolled evenly across the surface, making sure not to leave puddles or dry patches. Generally, spraying or rolling in a back-and-forth manner should be avoided as it may lead to overlapping.

In applying a water repellant penetrating sealer, one should generally follow manufacturer instructions. Generally (and subject to manufacturer instructions):

Generally speaking, most water repellent penetrating sealers require only one coat, but some may benefit from a second coat. If a second coat is to be applied, one should follow the manufacturer's recommendations on drying time between coats, with any second coat applied while the first coat is still damp for better adhesion.

After about 10-15 minutes, one should check for any remaining water repellent penetrating sealer that absorbed. If any residue remains, one may use a clean, dry cloth or mop to wipe away any residue and avoid a glossy or blotchy finish.

The treated surface should be allowed to cure for at least 24 hours before subjecting it to foot traffic, and 48-72 hours before heavy use or exposure to water.

### Preparation of Surface of Contaminated Cementitious Product

To ensure optimum curing of the penetrating sealer composition into the cementitious product, an open capillary system should ideally be obtained prior to application. This means that all agents that may reduce optimum conditions should be removed, such as: surface laitance, hydrocarbons and like materials such as engine or cooking oils, greases, fats, paints and associated paint solvents, loose construction debris including dust, soil, etc., floor hardeners, curing compounds and/or mineral deposits, calcium carbonate, etc. More generally, any material that may reduce the ‘tooth and suction’ of the cementitious surface should be removed.

Unlike most topical coatings like epoxies, polyurethanes, and some acrylics, it is not typically necessary to prepare a cementitious product surface by acid etching, grinding, shot blasting, sand blasting, or scarifying the surface. Occasionally however, it may for example be necessary to remove an earlier sealant or other material from the surface of the cementitious product, and this may require grinding, scabbling, or shot blasting followed by removal of the resultant cementitious product dust via a vacuum cleaner. If conducted, the cementitious product dust waste generated by these physical processes should be collected and stored for future waste disposal. The machines used should also be decontaminated prior to any further use.

As discussed above, if a sodium silicate- or potassium silicate-based penetrating sealant is used, or if the relevant process involves treatment with a base treatment composition, the area to be treated may be saturated with water prior to application to maximise crystalline growth in the pore space of the cementitious product. This can be done during the high-pressure wash or by simple hosing over a period of time. Pooled or excess water should be removed to prevent contaminating the local environment. Any excess runoff water should be collected and disposed appropriately noting the likelihood of contamination. It should again be noted that some manufacturer's directions for application of a sodium silicate-based penetrating sealer to a dry surface.

### Project Work

To confirm the viability of the invention, the current inventors undertook research to confirm its effectiveness in reducing environmental contamination from a contaminated concrete slab.

The selected sites involved a concrete slab used as a wash down site for firefighting trucks and equipment. The treatment was conducted in a manner consistent with the above, however, for Project Site 1 a single treatment of base treatment composition was applied. The treatment composition was applied as a cementitious slurry by spray application, once the concrete slab had been pressure washed with water and saturated. Following application, the surface was kept moist for 5 days, and kept free from vehicle and pedestrian traffic for 14 days after treatment. After 14 days the facility was able to resume regular use.

Project Site 2, the treatment involved application of both the base treatment composition, and penetrating sealer composition. As part of the research, samples of runoff water were taken from the affected concrete sites, with the samples being taken prior to treatment (baseline conditions), and at various periods following the treatment. The base treatment composition was applied in a similar fashion from Project Site 2 to Product Site 1, except that the base treatment composition was applied as a cementitious slurry by brush application at Project Site 2, after the concrete slab had been pressure washed with water and saturated. Following application, the surface was kept moist for 5 days, and kept free from vehicle and pedestrian traffic for 14 days after treatment. After 14 days the facility was able to resume regular use. Approximately 5 weeks after the base coat treatment, a sodium silicate-based top-coat penetrating sealer was applied to the dry concrete surface, and allowed to dry for 6 hours. Once completely dry, the treated concrete was flooded with abundant water to activate the penetrating sealer and left to dry. This process was repeated approximately 24 hours and 48 hours after the initial flooding to complete the activation process. After the third application of water, the treatment was completed, and the facility returned to regular use.

Table 1 below summarises the relevant results for Project Site 1, as follows whereby the concentration of PFAS in the runoff water (in micrograms per litre) was measured for identified PFAS compounds.

TABLE 1
Wash Down Pad Treatment Water Results (Project Site 1)

| | PFOS* | PFOA** | PFHxS*** | PFAS**** |
|---|---|---|---|---|
| Assessment Timing | (μg/L) | (μg/L) | (μg/L) | (μg/L) |
| Pre-treatment | 1.92 | 0.08 | 0.44 | 3.29 |
| 5-months post-treatment | 0.85 | 0.03 | 1.34 | 1.34 |
| 5-years post-treatment | 0.291 | 0.004 | 0.047 | 0.383 |

*PFOS = perfluorooctane sulfonic acid
**PFOA = perfluorooctanoic acid
***PFHxS = perfluorohexane sulfonic acid
****PFAS = the sum of 28-30 PFAS compounds typically measured by analytical laboratories as part of a standard (full suite) PFAS test.

As Table 1 demonstrates, leaching of PFAS compounds from the concrete pad at Project Site 1 reduced significantly in the months and years following treatment, ultimately reducing by approximately 60% after five months following treatment, and by approximately 88% after 5 years following treatment.

TABLE 2
Wash Down Pad Treatment Water Results (Project Site 2)

| | PFOS* | PFOA** | PFHxS*** | PFAS**** |
|---|---|---|---|---|
| Assessment Timing | (μg/L) | (μg/L) | (μg/L) | (μg/L) |
| Pre-treatment | 24.0 | 0.74 | 13.0 | 53.0 |
| 1 day post-treatment | 0.95 | 0.011 | 0.12 | 1.161 |

*PFOS = perfluorooctane sulfonic acid
**PFOA = perfluorooctanoic acid
***PFHxS = perfluorohexane sulfonic acid
****PFAS = the sum of 28-30 PFAS compounds typically measured by analytical laboratories as part of a standard (full suite) PFAS test.

As Table 2 demonstrates, leaching of PFAS compounds from the concrete pad at Project Site 2, where a combined base coat and top coat treatment was implemented, reduced significantly immediately following completion of the combined treatment, ultimately reducing by approximately 98% one day after treatment was completed.

Fundamentally, the inventors have identified that treatment of cementitious products in accordance with the invention results in a long-term reduction of PFAS contamination caused by storm and wash water coming into contact with PFAS-contaminated concrete. The invention therefore provides a viable alternative to the costly exercise of removing (and safely disposing of) and replacing PFAS-contaminated products such as concrete slabs, culverts, installed concrete pipes and the like. In an alternative embodiment, the methodology of the invention may be applied to broken up cementitious materials (such as concrete rubble) to enable the broken-up materials to be disposed of as non-contaminated or lower-grade contaminated materials.

The inventors have further found that the above methodology may also be used to produce a concrete or cementitious product which is impermeable to PFAS contamination. The same methodology may therefore be used not only to treat PFAS contaminated cementitious products, but also to prevent PFAS contamination from occurring by producing a PFAS impermeable cementitious product.

It will be understood to persons skilled in the art of the invention that modifications may be made without departing from the spirit and scope of the invention. The embodiments and/or examples as described herein are therefore to be considered as illustrative and not restrictive.

1. A method of treating a cementitious product to reduce leaching of PFAS from the cementitious product, the method comprising:
identifying a cementitious product as either:
likely to be subject to PFAS contamination, the cementitious product not previously being subject to substantial PFAS contamination; or
contaminated with PFAS;
treating a surface of the cementitious product with a penetrating sealer composition; and
allowing the penetrating sealer composition to permeate into the cementitious product and cure within the cementitious product.

2. The method of claim 1, wherein the step of identifying a cementitious product comprises
identifying the cementitious product as likely to be subject to PFAS contamination, the cementitious product not previously being subject to substantial PFAS contamination.

3. The method according to claim 1, wherein the step of allowing the penetrating sealer composition to permeate into the cementitious product comprises allowing the penetrating sealer to permeate at least 3 mm into the cementitious product.

4. The method according claim 1, further comprising pre-treating the cementitious product to prepare the surface of the cementitious product for treatment with the penetrating sealer composition.

5. The method according to claim 4, wherein the step of pretreating the cementitious product comprises a treatment step to remove hydrocarbons and solvents from the surface of the cementitious product.

6. The method according to claim 4, wherein the step of pretreating the cementitious product comprises conducting a water wash or water soak of the surface of the cementitious product.

7. The method according to any one of claim 4, wherein the step of pretreating the cementitious product comprises applying a base treatment composition to the surface of the cementitious product, the base treatment composition comprising as dry components:
15-80 wt % cement;
5-50 wt % alkaline earth compounds; and
20-70 wt % silica sand.

8. The method according to claim 1, wherein the penetrating sealer composition is a densifying penetrating sealer composition.

9. The method according to claim 8, wherein the penetrating sealer composition is a silicate-based penetrating sealer composition or a silica-based penetrating sealer composition.

10. The method according to claim 8, wherein the penetrating sealer composition is a sodium silicate-based penetrating sealer composition, a potassium silicate-based penetrating sealer composition, a lithium silicate-based penetrating sealer composition or a colloidal silica-based penetrating sealer composition.

11. The method according to claim 1, wherein the penetrating sealer composition is a water repellant penetrating sealer composition, the water repellant penetrating sealer composition is selected from the group consisting of: a silicone-based penetrating sealer composition, a siloxane-based penetrating sealer composition, a siliconate-based penetrating sealer composition, or a silane-based penetrating sealer composition, and combinations thereof.

12. The method according to claim 1, wherein the method comprises breaking up the cementitious product prior to treatment with any composition.

13. A method of treating a cementitious product to reduce leaching of PFAS from the cementitious product, the method comprising:
identifying a cementitious product as either:
likely to be subject to PFAS contamination, the cementitious product not previously being subject to substantial PFAS contamination; or
contaminated with PFAS;
treating a surface of the cementitious product with a base treatment composition, the base treatment composition comprising as dry components:
15-80 wt % cement;
5-50 wt % alkaline earth compounds; and
20-70 wt % silica sand; and
allowing the base treatment composition to permeate into the cementitious product and cure within the cementitious product.

14. The method according to claim 13, wherein the base treatment composition comprises as dry components:
15-80 wt % cement;
5-50 wt % alkaline earth compounds;
20-70 wt % silica sand and/or quartz;
5-30 wt % sodium carbonate;
0-15 wt % calcium aluminates;
0-10 wt % iron oxide;
0-10 wt % limestone;
0-5 wt % gypsum; and
0-5 wt % titanium dioxide.

15. The method according to claim 13, wherein the base treatment composition comprises as dry components:
35-60 wt % cement;
5-20 wt % alkaline earth compounds; and
30-40 wt % silica sand.

16. The method according to claim 13, wherein the cement used in the base treatment composition comprises Portland cement.

17. The method according to claim 13, wherein the base treatment is applied to the surface of the cementitious product at a rate of 0.3-2.0 kilograms of dry components per square meter.

18. The method according to claim 13, further comprising maintaining the surface of the cementitious product in a moist condition following application of the base treatment composition to facilitate curing of the base treatment composition.

19. The method according to claim 18, wherein the surface of the cementitious product is kept moist following application of the base treatment composition for between 2 to 7 days.

20. The method according to claim 13, wherein the method comprises breaking up the cementitious product prior to treatment with any composition.
